(19) United States
(12) Patent Application Publication
(10) Pub. No.: US 2008/0251010 A1
(43) Pub. Date: Oct. 16, 2008

(54) Automatic Painting Device

(76) Inventor: Ted Atwood, Paradise, CA (US)

Correspondence Address: ADVANTIA LAW GROUP, 9035 SOUTH 1300 EAST, SUITE 200, SANDY, UT, 84094, US

(21) Appl. No.: 11/735,220

(22) Filed: Apr. 13, 2007

(51) Int. Cl. B05C 5/00

(52) U.S. Cl. 118/305

(57) ABSTRACT

An automatic painting device. There is: a vertical track member; a paint applicator, slidably coupled to the vertical track member; a top bracketing drive mechanism, coupled to a top of the vertical track member; a bottom drive mechanism, coupled to a bottom of the vertical track member opposite the top bracketing drive mechanism; a power module, in communication with the top bracketing drive mechanism; and a control module, in communication with the power module. The top bracketing drive mechanism includes: a top horizontal arm member; a top vertical arm member; a top bracket wheel; a front angular arm member; a first front bracket wheel; a second front bracket wheel; a top rear arm member; and a rear bracket wheel. The bottom drive mechanism includes: a bottom horizontal arm member; and a bottom front wheel.

### BACKGROUND OF THE INVENTION

1. Field of the Invention

The present invention relates to automatic painting devices, specifically automatic painting devices for painting surfaces.

2. Description of the Related Art

Generally, the painting or coating of a surface is often accomplished by manual labor with brushes, rollers, or the use of spray equipment. For large projects, brushes and rollers are often difficult to use, and the cost of manual labor is usually prohibitive, discouraging proper maintenance. In addition, scaffolding, or ladders are often required to reach projects of great heights, creating a dangerous situation.

Accordingly, automatic painting devices and systems are often used to paint surfaces. For example, robots which paint are often used to paint a surface. Robots are often programmed to paint a surface by spraying paint on the surface. Further, robots which paint are often controlled by manual controls.

However, installation of automatic painting devices and systems is often difficult and confusing. In addition, automatic painting devices and systems are often inaccurate, resulting in painting unwanted surfaces and requiring touch-ups. Some improvements have been made in the field. Examples include, but are not limited to, the references described below, which references are incorporated by reference herein:

U.S. Pat. No. 4,944,243, issued to Takeno, et al., discloses a system for automatically painting the external wall of a building, in which a support is suspended from a hoist apparatus disposed on the roof of the building, and a painting apparatus is supported by the support in such a manner as to be movable horizontally. The painting apparatus includes a mechanism for advancing and retracting, in a direction normal to the wall surface, a painting hood having a spray gun disposed therein, a mechanism for swinging the hood laterally, and a frame formed of mounted on the peripheral edge of an opening of the hood which opposes the wall surface. When the painting is positioned opposite the wall surface, the frame is brought into close contact with the wall surface, thereby sealing the painting hood against the wall surface and preventing any scattering of paint mist.

U.S. Pat. No. 6,467,978 B1, issued to Tideman, Jr., discloses a system for automatically reproducing an image on a large surface, such as the external wall of a building or a billboard. The system includes a computer, a translator program, a controller card and image reproduction machinery. The computer is programmed with the translating program which converts a downloaded image file into a data file capable of being used by the controller card. The controller card is used to control drivers which control various motors on the image reproduction machinery. The image production machinery comprises a guide rail, a carriage, and a medium head assembly. The guide rail is suspended adjacent to the surface to be painted. During operation, the guide rail moves along one axis of the surface and the carriage moves longitudinally over the guide rail. The medium head assembly contains a plurality of airbrushes which are equally spaced apart with their tips aimed at a single point on the wall thereby producing a single pixel of various colors and shades.

U.S. Pat. No. 3,847,112, issued to Wise, discloses a mobile paint applying unit including a truck having a flat bed which carries the paint applying means and operating mechanism, said bed being provided with four wheels, which may be power driven or, to provide for manual movement thereof along the base of a wall being painted. Means are provided to adapt the automatic house painter to the use of a paint brush having a tubular handle, a rotary type brush, a roller or a paint spray gun. In general, the house painter of the present invention is either power or manually driven along the base of a wall to be painted and applies paint to said wall as the movement progresses.

U.S. Pat. No. 1,440,147, issued to Heinrich, discloses a painting apparatus for use in painting oil tanks, ships, and the like, the object being to suspend a paint tank or container provided with a spray head from and adjustable boom, whereby compressed air supplied to the spray head through the flexible tube leading from a source of compressed air may be utilized in spraying paint on the surface or wall to be painted, means being provided whereby the operator may adjust the tank and its carried spray head vertically to paint the surface in vertical strips. The paint tank is counterbalanced, and as the paint is used form the tank, weights may be added to the tank to compensate for its gradually lessening paint content. Weighted guide ropes serve to hold the tank and spray head the proper distance from the surface to be painted. Wind shield may also be provided on each side, or on one side, of the spray head to prevent wind from blowing the paint spray away from the wall.

U.S. Pat. No. 4,417,542, issued to Bellafiore, discloses an apparatus for applying a coating to one of two walls forming a narrow vertical elongated space comprising a vertical guide track supporting a vertically displaceable carriage thereon adapted to removably fit in the said narrow vertical elongated space; a power driven system for vertically displacing the carriage; and a system supported by the guide track for releasably securing the guide track against movement lateral to the two walls and sideways in the narrow vertical elongated space.

The inventions heretofore known suffer from a number of disadvantages, which include: being difficult to install, being difficult to use, being inaccurate, being expensive, and/or being bulky.

What is needed is an automatic painting device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available automatic painting device. Accordingly, the present invention has been developed to provide an automatic painting device for automatically painting a surface.

In one embodiment of the invention, there is an automatic painting device for automatically painting a surface, including: a vertical track member; a paint applicator, slidably coupled to the vertical track member, configured to apply paint; a top bracketing drive mechanism, coupled to a top of the vertical track member; a bottom drive mechanism, coupled to a bottom of the vertical track member opposite the top bracketing drive mechanism; a power module, in communication with the top bracketing drive mechanism, configured to provide power to drive the automatic painting device along a surface; and/or a control module, in communication with the power module, configured to control the power module. The top bracketing drive mechanism includes: a top horizontal arm member, coupled to the top of the vertical track member and/or extending outwardly therefrom in a substantially orthogonal orientation; a top vertical arm member, coupled to the top horizontal arm member near an end opposite the vertical track member and/or extending downwardly therefrom in a substantially orthogonal orientation; a top bracket wheel, coupled to a back side of the top vertical arm member near an end opposite the top horizontal arm member, configured to roll along a top of a surface; a front angular arm member, coupled to a front side of the top vertical arm member near an end opposite the top horizontal arm member and/or extending downwardly therefrom; a first front bracket wheel, coupled to an end of the front angular arm member, configured to roll along a front of a surface; a second front bracket wheel, coupled to an end of the front angular arm member opposite the first front bracket wheel, configured to roll along a front of a surface; a top rear arm member, coupled to the top bracket wheel and/or extending downwardly therefrom substantially orthogonal to the front angular arm member; and/or a rear bracket wheel, coupled to the top rear arm member, configured to roll along a rear of a surface. Also, the bottom drive mechanism includes: a bottom horizontal arm member, coupled to the bottom of the vertical track member and/or extending outwardly therefrom substantially parallel to the top horizontal arm member; and/or a bottom front wheel, coupled to the horizontal bottom arm member near an end opposite the vertical track member, configured to roll along a front of a surface.

In another embodiment of the invention, the power module includes: a first motor, in communication with the top bracketing drive mechanism, configured to provide power to the top bracketing drive mechanism; a second motor, in communication with the paint applicator, configured to provide power to the paint applicator; and/or a third motor, in communication with the bottom drive mechanism, configured to provide power to the bottom drive mechanism. In still another embodiment of the invention, the top bracketing drive mechanism maybe removably coupled to the top of the vertical track member. In yet another embodiment of the invention, the control module includes a CPU.

In a further embodiment of the invention, the control module includes: a vertical distance applicator module, in communication with the CPU, configured to program the paint applicator to paint a vertical distance of a surface to be painted; a horizontal distance applicator module, in communication with the CPU, configured to program the paint applicator to paint a horizontal distance of a surface to be painted; a drive speed module, in communication with the CPU, configured to program a drive speed of the top bracketing drive mechanism and/or a drive speed of the bottom drive mechanism; a paint speed module, in communication with the CPU, configured program a paint speed of the paint applicator; and/or a start/stop applicator module, in communication with the CPU, configured to program a start and/or a stop of the paint applicator. In still a further embodiment of the invention, the vertical track member may be telescopically adjustable. In yet a further embodiment of the invention, the paint applicator includes a spray tip member, configured to apply paint to a surface by spraying. In still yet a further embodiment of the invention, the paint applicator includes a plurality of spray tip members, disposed along a vertical axis of the vertical track member, configured to apply paint to a surface by spraying.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a front perspective view of an automatic painting device, according to one embodiment of the invention;

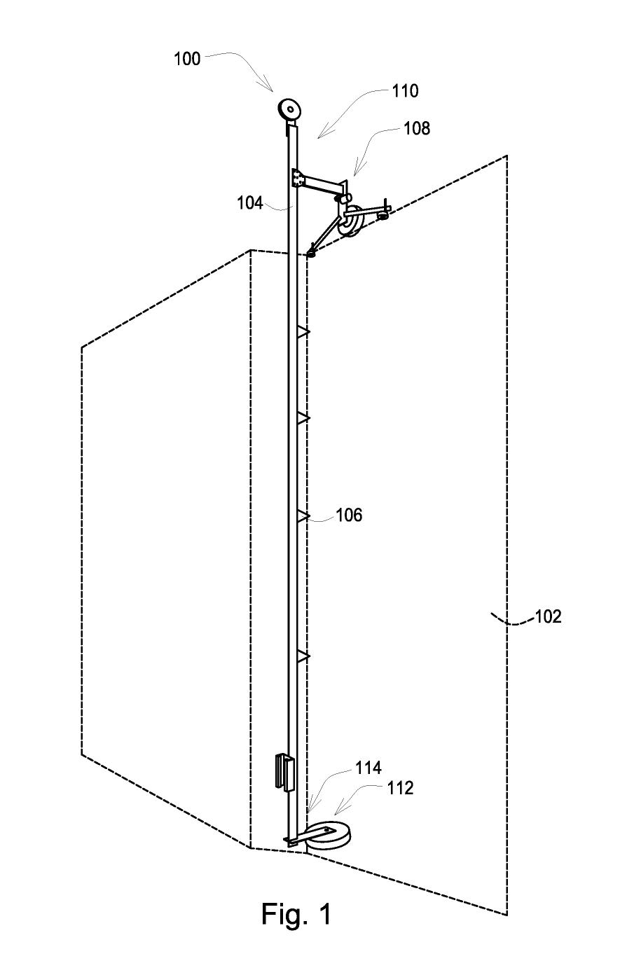

FIG. 2 is a rear perspective view of a top bracketing drive mechanism, according to one embodiment of the invention;

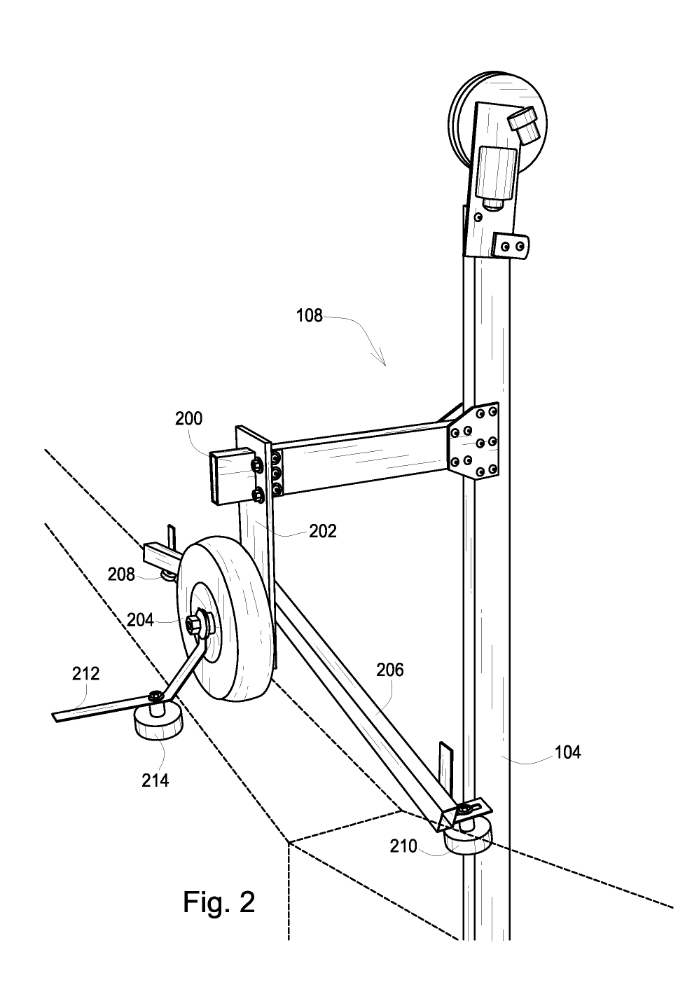

FIG. 3 is a front perspective view of a bottom drive mechanism, according to one embodiment of the invention;

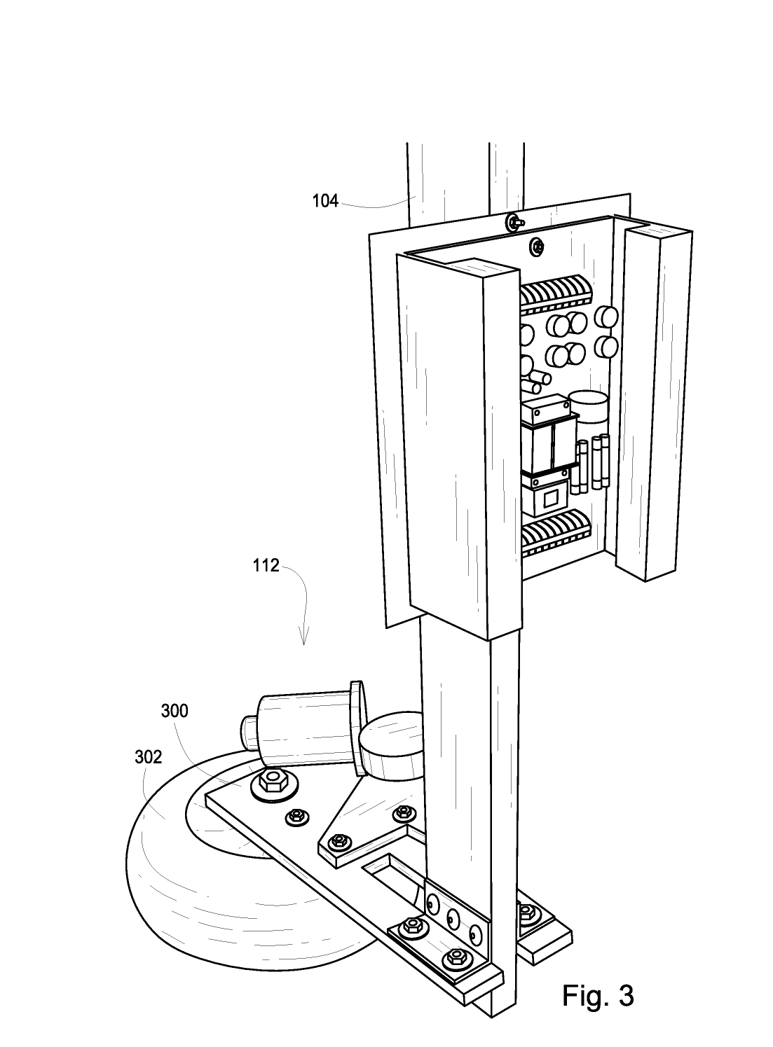

FIG. 4 is a block diagram of an automatic painting device, according to one embodiment of the invention; and

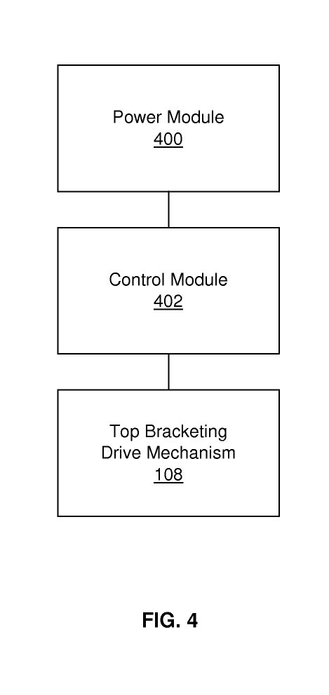

FIG. 5 is a block diagram of an automatic painting device, according to one embodiment of the invention; and

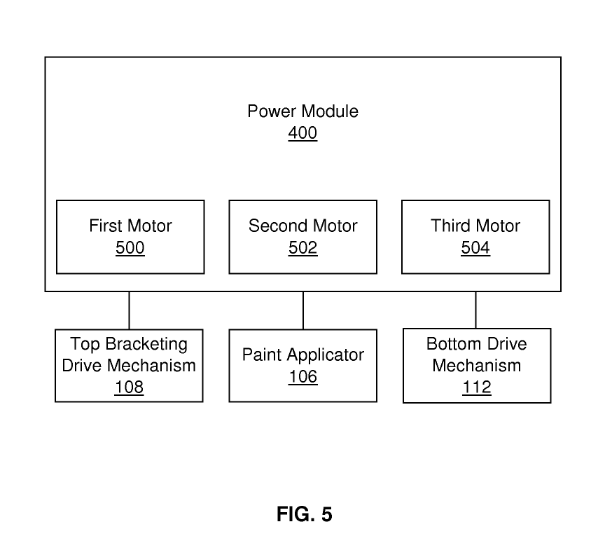

FIG. 6 is a block diagram of an automatic painting device, according to one embodiment of the invention.

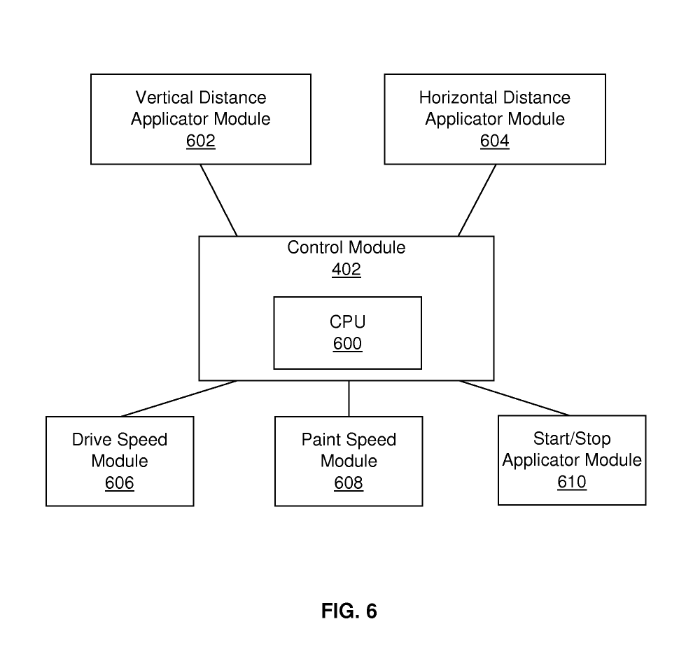

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As illustrated by the figures, there is an automatic painting device 100 for automatically painting a surface 102. For example, the automatic painting device 100 may paint a wall. As shown, the automatic painting device 100 has a vertical track member 104 with a paint applicator 106 slidably coupled to the vertical track member 104. The paint applicator 106 is slidably coupled to the vertical track member 104 so that the paint applicator 106 can adjust vertically to apply paint at different heights. For example, in one embodiment of the invention, the paint applicator 106 may be slidably coupled to the vertical track member 104 by pulleys and cables. In another embodiment of the invention, the paint applicator 106 includes a spray tip member for applying paint to a surface 102 by spraying. For example, the paint applicator 106 may be such as the spray gun described in U.S. Pat. No. 4,944,243, issued to Takeno et al., which is incorporated by reference herein.

Also, the figures illustrate a top bracketing drive mechanism 108 coupled to a top of the vertical track member 110, and a bottom drive mechanism 112 coupled to a bottom of the vertical track member 114, opposite the top bracketing drive mechanism 108. In operation of one embodiment of the invention, the top bracketing drive mechanism 108 and the bottom drive mechanism 112 drive the automatic painting device along a surface 102 to be painted. For example, the top bracketing drive mechanism 108 and the bottom drive mechanism 112 may be such as the truck of U.S. Pat. No. 3,847,112, issued to Wise, which is incorporated by reference herein.

Further, as shown by the figures, the top bracketing drive mechanism 108 has a top horizontal arm member 200, a top vertical arm member 202, a top bracket wheel 204, a front angular arm member 206, a first front bracket wheel 208, a second front bracket wheel 210, a top rear arm member 212, and a rear bracket wheel 214. In one embodiment of the invention, the top bracketing drive mechanism 108 brackets a surface 102, such as a wall, for coupling the automatic painting device 100 to the surface 102 for painting. For example, the first front bracket wheel 208 and the second front bracket wheel 210 may roll along a front of a surface 102, while the top bracket wheel 204 rolls along a top of the surface 102, and while the rear bracket wheel 214 rolls along a rear of the surface 102.

In addition, the figures show a bottom drive mechanism 112 with a bottom horizontal arm member 300 and a bottom front wheel 302. In one embodiment of the invention, the bottom drive mechanism 112 rolls along a bottom of a surface 102 in concert with the top bracketing drive mechanism 108. For example, the bottom front wheel 302 may be driven along a bottom of a surface 102 by the bottom drive mechanism 112.

More, as illustrated by the figures, the automatic painting device 100 includes a power module 400 in communication with the top bracketing drive mechanism 108, and a control module 402 in communication with the power module 400. In one embodiment of the invention, the power module 400 is configured to provide power to drive the automatic painting device 100 along a surface 102, and the control module 402 is configured to control the power module 400. For example, the power module 400 may be such as the electric motor of U.S. Pat. No. 3,847,112, issued to Wise, which is incorporated by reference herein, and the control module 402 may be such as the on/off switches of U.S. Pat. No. 3,847,112, issued to Wise, which is incorporated by reference herein.

Additionally, the figures show that in one embodiment of the invention the power module 402 includes a first motor 500 in communication with the top bracketing drive mechanism 108, a second motor 502 in communication with the paint applicator 106, and a third motor 504 in communication with the bottom drive mechanism 112. For example, the first motor 500, the second motor 502, and the third motor 504 may be such as the electric motors as described in U.S. Pat. No. 3,847,112, issued to Wise, which is incorporated by reference herein. Alternatively, the first motor 500, the second motor 502, and the third motor 504 could be pneumatic motors or hydraulic motors with a belt, chain, or cable drive system. Accordingly, in one embodiment of the invention the first motor 500, the second motor 502, and the third motor 504 provide power to the moving parts of the automatic painting device 100.

Furthermore, as shown by the illustrated figures the control module 402 includes a central processing unit (“CPU”), such as the CPUs at http://www.cpu.com. In addition, the CPU is in communication with a vertical distance applicator module 602, a horizontal distance applicator module 604, a drive speed module 606, a paint speed module 608, and a start/stop applicator module 610. In one embodiment of the invention, the vertical distance applicator module 602 programs the paint applicator 106 to paint a vertical distance of a surface 102 to be painted. In another embodiment of the invention, the horizontal distance applicator module 604 programs the paint applicator 106 to paint a horizontal distance of a surface 102 to be painted. In an additional embodiment of the invention, the drive speed program module 606 programs a drive speed of the top bracketing drive mechanism 108 and the bottom drive mechanism 112. In a further embodiment of the invention, the paint speed program module 608 programs a paint speed of the paint applicator 106. In yet another embodiment of the invention, the start/stop applicator module programs a start and a stop of the paint applicator 106. For example, the vertical distance applicator module 602, the horizontal distance applicator module 604, the drive speed program module 606, the paint speed program module 608, and the start/stop applicator module 610 may include source code, assembly code, and/or machine code.

In operation of one embodiment of the invention, a user applies paint to a surface 102 with an automatic painting device 100. First, the user couples the automatic painting device 100 to a surface 102 by bracketing a top of the surface with a top bracketing drive mechanism 108 so that a vertical track member 104, coupled to the bracketing drive mechanism 108, extends downwardly along the surface 102, and so that a bottom drive mechanism 112 rests near ground level. Next, the user turns on a power module 400 to provide power to the automatic painting device 100.

After providing power to the automatic painting device 100, the user programs the automatic painting device 100. The user programs the automatic painting device 100 to paint a surface area by programming a vertical distance to be painting as well as a horizontal distance to be painted. The user also programs the drive speed of the top bracketing drive mechanism 108 and the bottom drive mechanism 112 according to how fast the user desires the automatic painting device 100 to travel horizontally along the surface 102. In addition, the user programs the paint speed of a paint applicator 106 of the automatic painting device 100, including how fast the user desires the paint to be applied, and how fast the user desires the paint applicator 106 to slide along a vertical track member 104 of the automatic painting device 100. Finally, the user programs a start and a stop of the applicator module 106 according to the length of time the user desires the automatic painting device 100 to apply paint. Once the user programs a start of the applicator module 106, the automatic painting device 100 begins to paint a surface 102.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, the paint applicator 106 may be any device configured to apply paint. In one embodiment of the invention, the paint applicator 106 may be a spray tip or a nozzle for spraying, such as the spray gun described in U.S. Pat. No. 4,944,243, issued to Takeno et al., which is incorporated by reference herein. Similarly, the paint applicator 106 could include a brush or a roller for applying paint to a surface 102. Likewise, the automatic painting device 100 could include a plurality of paint applicators, or spray tip members 106, disposed along a vertical axis of the vertical track member 104. In addition, the spray tip members 106 could be removably coupled to the vertical track member 104 so that the number of spray tip members 106 coupled to the automatic painting device 100 could be varied. For example, the automatic painting device could include one, seven, or ten paint applicators 106.

Similarly, the paint applicator 106 may be a spray bar, and/or may be elongated, so that the paint applicator 106 is configured to spray paint along a plane. In addition, the paint applicator 106, or spray bar, may be removably and/or rotatably coupled to the vertical track member 104 so that the spray bar may be disposed at any angle with respect to the vertical axis of the vertical track member 104. For example, one skilled in the art would appreciate that the spray bar may be disposed parallel to, or orthogonal to, the vertical axis of the vertical track member 104.

Moreover, although the figures illustrate an automatic painting device 100 that includes electric motors 500, 502, and 504, it is envisioned that the automatic painting device may be constructed, and operate, without motors and/or other electronic devices. For example, it is envisioned that the automatic painting device may include a manually operated wench, or crank, that moves that paint applicator 106 along the vertical track member 104 when operated. Likewise, it is envisioned that the automatic painting device 100 may be manually driven along a wall. For example, a user may move the automatic painting device 100 along a wall by pushing, pulling, or otherwise applying force to the automatic painting device.

Additionally, although the figures illustrate that the power module 400 is in communication with the top bracketing drive mechanism 108, the power module may be in communication with other components of the automatic painting device 100 as well. For example, the power module 400 may be in communication with the top bracketing drive mechanism 108, the bottom drive mechanism 112, and/or the paint applicator 106.

It is also envisioned that a height of the top bracketing drive mechanism 108 may be adjustable. For example, the top bracketing drive mechanism 108 may be slidably and/or adjustably coupled to the top of the vertical track member 110 so that the top bracketing drive mechanism 108 can be disposed at a top end of the vertical track member or near the middle of the vertical track member.

Further, it is envisioned that the automatic painting device 100 could be broken down, including removal and/or transformation of the components of the automatic painting device 100, for transportation of the device 100. For example, the top bracketing drive mechanism 108 could be removably coupled to the top of the vertical track member 110.

Also, it is envisioned that the automatic painting device 100 could have a variety of paint application functions. For example, the automatic painting device 100 could have the ability to roll behind a surface 102 that has been painted. In addition, the automatic painting device 100 could mask a surface 102 by painting an accent color stripe along the surface 102.

It is expected that there could be numerous variations of the design of this invention. For example, the vertical track member 104 could be telescopically adjustable to accommodate varying heights of surfaces 102 to be painted. Also, the automatic painting device 100 could be configured so as to be suitable for paint applications both indoors as well as outdoors.

Finally, it is envisioned that the components of the automatic painting device 100 may be constructed of a variety of materials. For example, the automatic painting device 100 may include materials, such as: metal, plastic, rubber, glass, and fiber composite materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An automatic painting device for automatically painting a surface, comprising:
a) a vertical track member;
b) a paint applicator, slidably coupled to the vertical track member, configured to apply paint;
c) a top bracketing drive mechanism, coupled to a top of the vertical track member, including:
c1) a top horizontal arm member, coupled to the top of the vertical track member and extending outwardly therefrom in a substantially orthogonal orientation;
c2) a top vertical arm member, coupled to the top horizontal arm member near an end opposite the vertical track member and extending downwardly therefrom in a substantially orthogonal orientation;
c3) a top bracket wheel, coupled to a back side of the top vertical arm member near an end opposite the top horizontal arm member, configured to roll along a top of a surface;
c4) a front angular arm member, coupled to a front side of the top vertical arm member near an end opposite the top horizontal arm member and extending downwardly therefrom;
c5) a first front bracket wheel, coupled to an end of the front angular arm member, configured to roll along a front of a surface;
c6) a second front bracket wheel, coupled to an end of the front angular arm member opposite the first front bracket wheel, configured to roll along a front of a surface;
c7) a top rear arm member, coupled to the top bracket wheel and extending downwardly therefrom substantially orthogonal to the front angular arm member; and
c8) a rear bracket wheel, coupled to the top rear arm member, configured to roll along a rear of a surface;
d) a bottom drive mechanism, coupled to a bottom of the vertical track member opposite the top bracketing drive mechanism, including:
d1) a bottom horizontal arm member, coupled to the bottom of the vertical track member and extending outwardly therefrom substantially parallel to the top horizontal arm member; and
d2) a bottom front wheel, coupled to the horizontal bottom arm member near an end opposite the vertical track member, configured to roll along a front of a surface;
e) a power module, in communication with the top bracketing drive mechanism, configured to provide power to drive the automatic painting device along a surface; and
f) a control module, in communication with the power module, configured to control the power module.

2. The automatic painting device of claim 1, wherein the power module comprises:
a) a first motor, in communication with the top bracketing drive mechanism, configured to provide power to the top bracketing drive mechanism;
b) a second motor, in communication with the paint applicator, configured to provide power to the paint applicator; and
c) a third motor, in communication with the bottom drive mechanism, configured to provide power to the bottom drive mechanism.

3. The automatic painting device of claim 2, wherein the top bracketing drive mechanism is removably coupled to the top of the vertical track member.

4. The automatic painting device of claim 3, wherein the control module comprises a CPU.

5. The automatic painting device of claim 4, wherein the control module comprises:
a) a vertical distance applicator module, in communication with the CPU, configured to program the paint applicator to paint a vertical distance of a surface to be painted;
b) a horizontal distance applicator module, in communication with the CPU, configured to program the paint applicator to paint a horizontal distance of a surface to be painted;
c) a drive speed module, in communication with the CPU, configured to program a drive speed of the top bracketing drive mechanism and a drive speed of the bottom drive mechanism;
d) a paint speed module, in communication with the CPU, configured program a paint e speed of the paint applicator; and
e) a start/stop applicator module, in communication with the CPU, configured to program a start and a stop of the paint applicator.

6. The automatic painting device of claim 5, wherein the vertical track member is telescopically adjustable.

7. The automatic painting device of claim 6, wherein the paint applicator comprises a spray tip member, configured to apply paint to a surface by spraying.

8. The automatic painting device of claim 7, wherein the paint applicator comprises a plurality of spray tip members, disposed along a vertical axis of the vertical track member, configured to apply paint to a surface by spraying.
